(19) United States
(12) Patent Application Publication
(10) Pub. No.: US 2024/0386705 A1
(43) Pub. Date: Nov. 21, 2024

(54) Automatic Recognition of Equipment Configuration

(71) Applicant: Mark Sullivan, Dunlap, IL (US)

(72) Inventor: Mark Sullivan, Dunlap, IL (US)

(21) Appl. No.: 18/666,990

(22) Filed: May 17, 2024

Related U.S. Application Data
(60) Provisional application No. 63/467,200, filed on May 17, 2023.

(51) Int. Cl. G06V 10/77; G06F 3/0482; G06Q 30/0601; G06V 10/764; G06V 10/96; H04N 23/61

(52) U.S. Cl. CPC G06V 10/7715; G06Q 30/0621; G06V 10/764; G06V 10/96; H04N 23/61; G06F 3/0482

(57) ABSTRACT

The system that enables the classification and description of goods is described. The system is based on a combination of a user device with a graphical user interface that captures images, video, and/or audio of an object, such as farm equipment or construction equipment. The user device provides the information to a computing device running a classification model trained through machine learning. Training data may include sensor data (e.g., multimedia data such as images, video, and audio) depicting existing equipment in various configurations and corresponding data sets characterizing the equipment in those configurations.

### CROSS REFERENCE TO RELATED APPLICATIONS

This application claims priority to U.S. Provisional Patent Application No. 63/467,200, titled “SYSTEMS AND METHODS FOR AUTOMATIC RECOGNITION OF EQUIPMENT CONFIGURATION,” and filed May 17, 2023. The above-referenced application is incorporated herein by reference in its entirety.

### FIELD

Aspects described relate generally to automated visual recognition, including identifying object configuration based on features of the object captured in image data.

### BACKGROUND

Certain types of goods are highly configurable and/or modified with aftermarket parts. Examples include complex machines such as automotive, construction, agricultural, and industrial equipment, but other examples can include consumer goods (e.g., exercise equipment, electronics, musical instruments, etc.). The particular configurations and/or modifications are often critical to the product's suitability for a given purchaser's needs.

However, this type of information is often challenging to capture, particularly in secondary markets, such as auctions, used dealerships, thrift stores, and the like, where the original configuration information may be lost or unavailable. Similarly, aftermarket modifications will not be reflected in the original purchase information. In some cases, the person selling the equipment is unaware that these configuration options are important. In others, the options are not readily apparent, or the information cannot be entered into a listing due to limitations in the type and amount of information that the listing service will accept.

### SUMMARY

The following is a simplified summary of various aspects described herein and is not an extensive overview. It is not intended to identify essential or critical elements or delineate any claim's scope. The following merely presents some concepts as an introduction to the more detailed description provided below.

The system that enables classifying and describing goods such as complex machines is described. The system is based on a combination of a user device with a graphical user interface that captures images, video, audio, and/or other sensor data of an object, such as farm equipment. It provides that information to a computing device running a classification model trained through machine learning. Training data may include sensor data (e.g., multimedia data such as images, video, and audio) depicting existing equipment in various configurations and corresponding data sets characterizing the equipment in those configurations.

The user interface may provide options to the user to confirm certain information generated by the model, which may be provided back to the model for further training and/or refinement of the information about the item. The model, e.g., via the user interface, may also provide a neutral assessment of the overall condition of equipment and age of manufacture and/or suggest a fair market price.

The application may direct the user in gathering the information, such as identifying different views (e.g., different angles and distances) from which to capture sensor data (e.g., images, video, audio). Particular views may be predetermined or may be determined by the classification model based on already captured and processed inputs (e.g., images, video, and/or audio) and/or based on the user confirming the correctness of information generated by the model.

### BRIEF DESCRIPTION OF THE DRAWINGS

The present disclosure is illustrated by way of example and not limited to the accompanying figures in which like reference numerals indicate similar elements and in which the figures depict the following.

FIG. 1 depicts an example schematic representation of a system for recognition of equipment configuration according to the present disclosure.

FIG. 2 depicts an example method according to the present disclosure.

FIG. 3 depicts an example user interface for a user device according to the present disclosure.

FIG. 4 depicts an example method for refining results generated by the ML model(s) according to the present disclosure.

FIG. 5 illustrates a system that hosts, trains, and runs the ML model(s) according to the present disclosure.

FIG. 6 illustrates a method performed by the system, as illustrated in FIG. 5, according to the present disclosure.

FIG. 7 depicts an example computing device according to the present disclosure.

### DETAILED DESCRIPTION

Creating and maintaining accurate information regarding an inventory of goods can be complex and cumbersome. This may be especially true where the goods (e.g., complex machines) are highly configurable and/or modifiable with standard, or even aftermarket, parts. Examples of such goods include automotive, construction, agricultural, and industrial equipment, but this can also apply to other products, such as consumer goods (e.g., exercise equipment, electronics, computers, musical instruments, etc.). The particular configurations and/or modifications are often critical to the product's suitability for the needs of a specific user, purchaser, or business.

For example, in secondary/used sales markets, such as auctions, used dealerships, thrift stores, and the like, original configuration information may be lost or unavailable, and aftermarket modifications will not be reflected in original purchase information. In some cases, the person selling the equipment is unaware that these configuration options are important. In others, the options are not readily apparent, or the information cannot be entered into a listing due to limitations in the type and amount of information that the listing service will accept.

Another example is the management of equipment inventory used by multiple individuals at multiple locations, especially where parts on the equipment are configurable or interchangeable. For example, a construction company that maintains a fleet of construction vehicles and equipment may have this equipment constantly reconfigured with different attachments and continually shuffled among construction sites. A similar issue may arise for an equipment leasing company that continually redistributes its equipment in varying configurations to customers. Tracking those vehicles and equipment and their relative conditions is time-intensive and often prone to human error.

To deal with these problems, people such as listing agents and inventory managers may personally inspect the equipment in question, take photographs of it, inspect it, and take note of the configuration options. These photographs can then be posted with the listing. However, even this method can overlook key configuration information, especially with new listing agents who lack familiarity with all the possible options. Additionally, although the configuration details can often be determined simply by looking at the equipment, they cannot be searched for by a user with adequate specificity. If the listing agent doesn't take photos of the correct portion of the equipment, the visual and database information necessary to identify the configuration may not be captured.

Additionally, there are situations where the interested person (e.g., someone looking to make a purchase) simply does not have and cannot reasonably access the relevant information. For example, a consumer may discover a used bulldozer or tractor at a dealership and desire information about its configuration, features, and approximate value but be unable to locate all the necessary information to search for that information accurately.

Because of these and other problems in the art, described herein, among other things, are systems and methods for training and using artificial intelligence (AI) (e.g., machine learning (ML)) classification technology to recognize configurations based on photographs taken of equipment with known configurations options, and training an ML model to recognize other equipment with the same arrangement of configuration options, with different arrangements of the configuration options, and to identify aftermarket modifications.

The AI/ML system may be trained using photographs, video, audio, and other sensor data of existing equipment in various configurations, along with corresponding data sets characterizing the equipment in those configurations to train one or more machine learning models to recognize similar equipment. Information about an item to be identified or characterized is then gathered with a user device, such as a tablet, laptop, or smartphone. The user device may run an application providing a user interface that directs the user in gathering the information, such as capturing images, video, or sound of the item to be recognized, which is input to the AI/ML model for processing. The AI/ML model, based on the previous training, may then generate information characterizing the item. That information may be stored in a database and/or presented to the user via the user interface. The user interface may be provided with options to confirm certain information generated by the model, which may be provided back to the model for further training and/or refinement of the information about the item. The model, e.g., via the user interface, may also provide a neutral assessment of the overall condition of equipment, age of manufacture, and/or suggest a fair market price.

In some examples, in response to a user (e.g., a new listing agent) capturing the equipment's images/video/audio, information automatically recognized may include the equipment's make, model, and year. A database of photographic views may be identified/suggested to the user via the user interface to ensure that the required image data is collected to determine the configuration data and assess the condition of the equipment and its accessories (e.g., tread depth on agricultural tires). Particular views (e.g., angles, distances, lighting, configurations, operating states) of the item identified to the user may be determined by the AI/ML model based on already captured and processed inputs (images, video, and/or audio) and/or based on the user confirming the correctness of information generated by the model. All of this may be managed through a device carried by the user (e.g., listing agent).

The system may be used in a number of scenarios, such as inventory management, secondary sales markets, and equipment dealerships. For example, in the sales or auctioning of agriculture equipment, an agent may take several photographs from different viewpoints of an item (e.g., a tractor) and process those photographs with the systems and methods described below to generate a record of the item, including a list of all the features included with the tractor, which may be used in the sales listing for the item. The generation of the record using the disclosed system and methods addresses several shortcomings and provides several advantages, such as generating information about the item that was incomplete or not provided by the manufacturer, highlighting any discrepancies between images of the item and a previously existing listing for the item, and/or identifying any additions of aftermarket parts or modifications from the standard equipment that originally came with the item. The system may further track changes to an item over time by repeating the process. For example, for a rental vehicle or equipment, the described process could be performed each time the item is provided to or returned from a user to identify damage to the item or the inclusion of all components that came with the item.

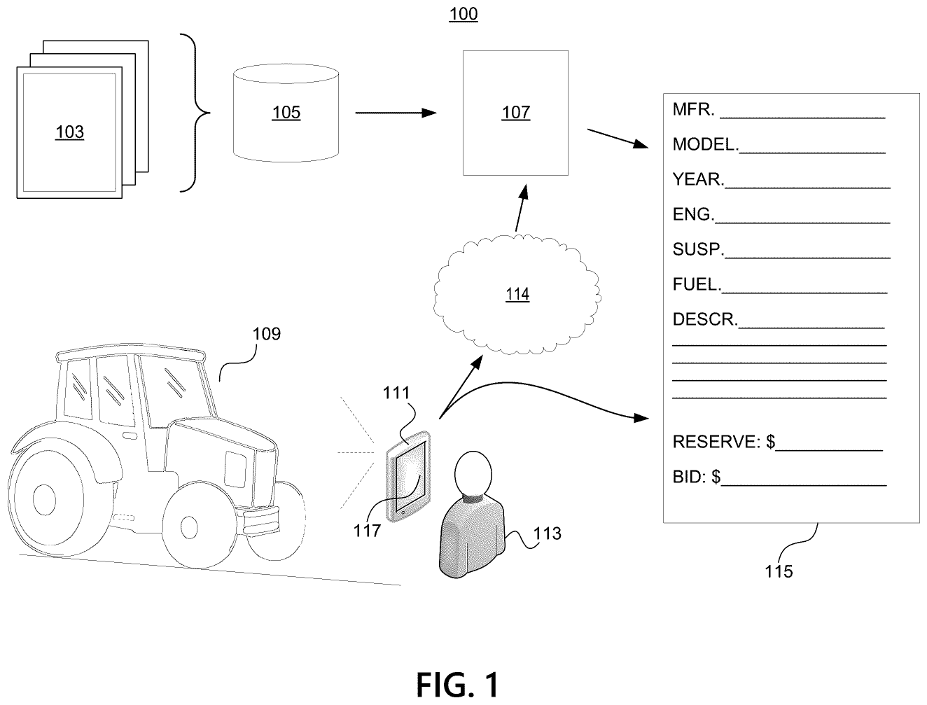

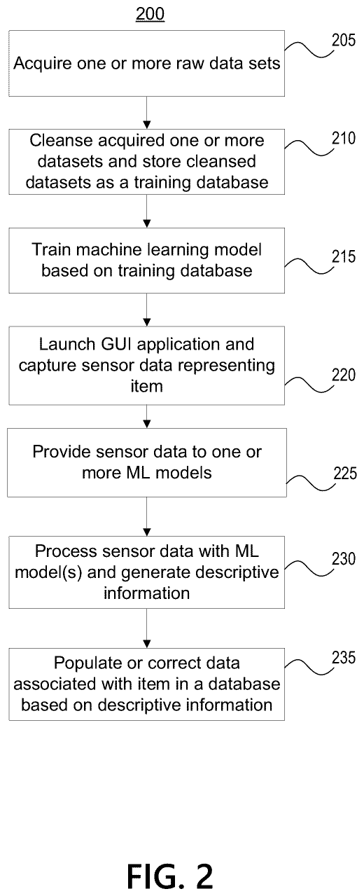

FIGS. 1 and 2 depict an example system 100 and process 200, respectively, for recognition of equipment configuration. In FIG. 1, a raw data set 103) (which may include multiple data sets) is illustrated, which may be acquired in step 205 by a computing system (e.g., a smartphone, laptop, server(s), etc.). This data set may include sensor data (e.g., photographs, video, and/or audio) depicting or representing certain items of the type of assets or equipment for which the particular feature sets or equipment models will be identified. For example, in the context of agricultural or industrial equipment auctions (and in other contexts), this data may be stock photos of off-the-line equipment, photos of used, worn, or modified equipment, and the images may include exterior photos, cabin photos, or detailed photos from specific angles or of particular equipment or features (e.g., dashboard or other panel layouts). At least some images should include the equipment elements that can be used to identify or estimate the model, year, modifications, and/or condition of the equipment or its components. The raw data set 103 may include descriptive information (e.g., make, model, year of manufacture, optional features, etc.) associated with the item(s) depicted or represented in the sensor data and relationship information that correlates the descriptive information to the sensor data.

This raw data set 103 may be sanitized and cleansed in step 210 into a training database 105. This process may involve one or more of: removing duplicate information, trimming (e.g., cropping) images to emphasize and/or deemphasize certain features, removing backgrounds, providing training inputs, such as identifying or flagging key components, and/or engaging in other techniques to prepare the data for use as a training set.

Next, step 215 uses the training database 105 to train an artificial intelligence/machine learning model 107 or a plurality of models 107. This process uses ML techniques to identify commonalities among photos and other sensor data in the training database to all or portions of the sensor data (e.g., an image) to certain classifications and sub-classifications (e.g., in the descriptive information). The classifications may include the manufacturer, model, year, engine, transmission, fuel capacity, fuel type, suspension, tire configuration, age, and similar information. Additionally, the model(s) 107 may be trained to estimate a condition based on observable features in the training database 105, such as tire wear, rust, dents, and so forth. Also, model(s) 107 may be trained to estimate a fair market value in various sales channels based on some or all preceding factors and possibly others. The model(s) 107 may be trained to create the classifications and sub-classifications based on the training database 105, for example, based on a combination of the sensor data, the descriptive data, and/or the relationship information in the training database 105.

The system may further include a user device (e.g., a tablet) 111, which may run an application 117 providing a graphical user interface (GUI) made available to a user 113 for capturing sensor data (e.g., images, video, audio), and accessing the ML models to generate descriptive information (e.g., within the classifications and subclassifications) about an item represented in the sensor data. The GUI may be a web page, a local application, or another software program. For example, a program generating the GUI 117 may be executed on, or via, user device 111, and the ML model may be hosted and run on a remote computer accessible over a telecommunications network 114 (e.g., the Internet). The connection of user device 111 to telecommunication network 114 may be wired or wireless (e.g., via WiFi, satellite, or cellular communications). In some instances, the ML model may be downloaded to and run on the user device 111, for example, in situations where the user device 111 lacks sufficient network connectivity (e.g., in remote rural areas where agricultural equipment is often found).

To use the model(s) 107, in step 220, user 113 launches the GUI application 117. It captures sensor data (e.g., images or video via a camera or audio via a microphone in or connected to user device 111) of item 109 (e.g., a tractor). In some examples, sensor data is captured by one device and transferred (e.g., by network or memory card) to the user device 111. The user 113 may capture a plurality of such images from various views (e.g., external views, cabin views, and views of specific components, etc.). The sensor data (e.g., images) are then provided in step 225 to the model(s) 107, hosted directly on the device 111 or via the telecommunications network 114. In step 230, the model(s) 107 may process the sensor data and, based on the previous training using training set 105, provide the various descriptive information (e.g., classifications, subclassifications) about item 109.

In step 235, the descriptive information (e.g., classification outputs) may be used to populate or correct data 115 associated with item 109 (e.g., stored in a database). FIG. 1 illustrates example data 115 (e.g., an auction description) for item 109 that may be populated using the descriptive information (e.g., classification output) from the model(s) 107. For example, the feedback may include a confidence level of the classification, which may be indicated by the GUI application 117, such as with a percentage or a color coding (e.g., a gradient from green to red, reflecting most to least confident). The descriptive information populated, which may be provided back to the GUI application 117, may include but is not limited to the manufacturer, model, year, engine model, suspension type, transmission model, fuel type, fuel capacity, starting bid, or a reserve amount. Additionally, a description of the asset 109 may be provided. This description could be automatically generated from the classification output, for example, using a template with merge fields or a generative language-based AI. The user, via GUI application, may then provide additional information to the ML model(s), for example, to manually update, modify, and/or confirm each field or to flag specific fields for confirmation or follow-up as further described below.

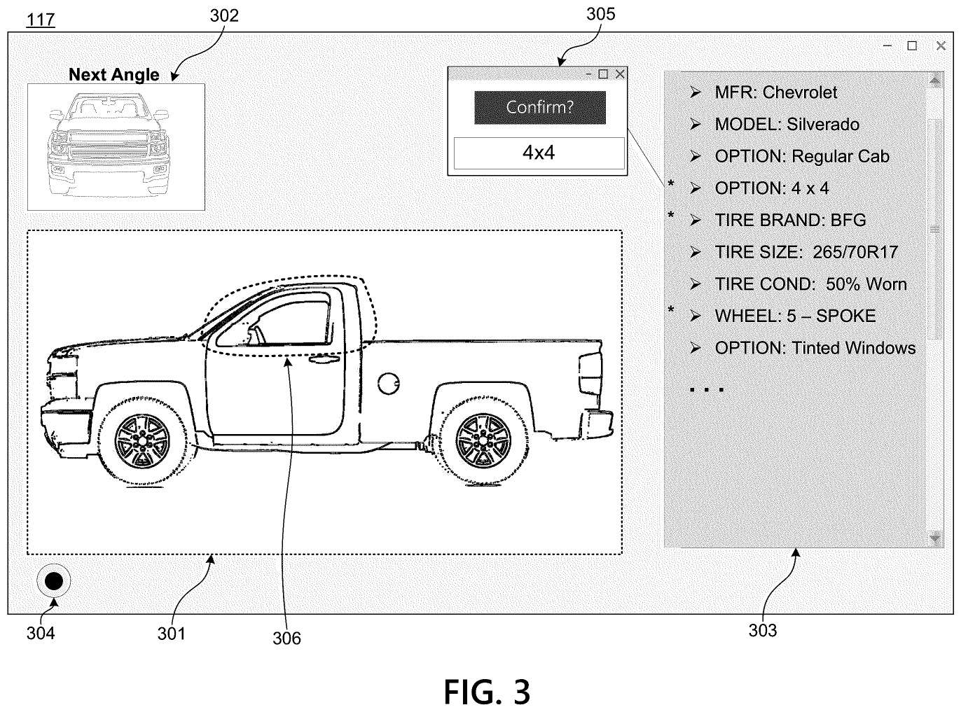

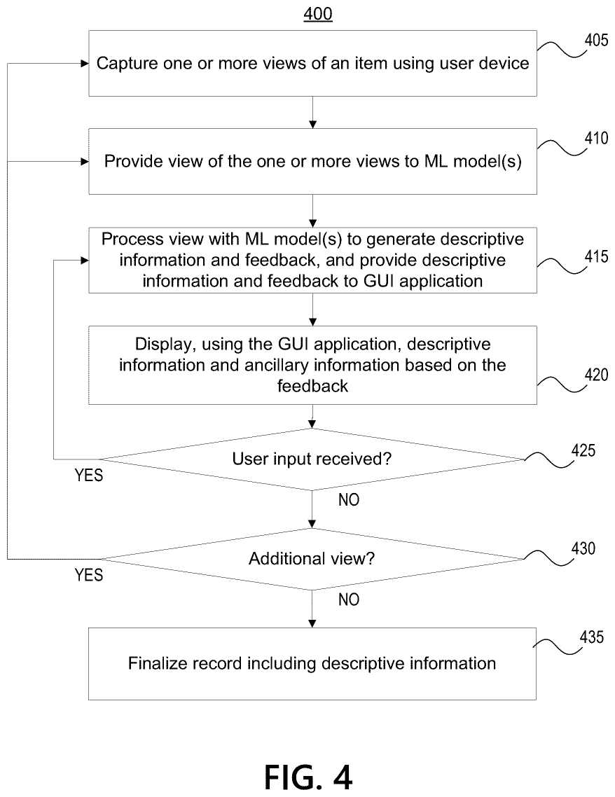

An example of GUI application 117 running on user device 111 is depicted in FIG. 3. FIG. 4 illustrates, with respect to FIG. 3, an iterative process 400 of exchanging information back and forth between GUI application 117 and ML model(s) 107 to further refine the descriptive information (e.g., classifications, subclassification) generated by the models and to further train the model(s). Process 400 may be performed by user device 111 and optionally by one or more other computing devices that host GUI application 117 (e.g., as a website) and/or model(s) 107 remotely from user device 111. Process 400 may be performed in conjunction with or as part of process 200, for example, as part of steps 220, 225, 230, and 235.

In step 405, the user device (via application 117) may provide a “live” or recorded view 301 of an item (e.g., a side view of a complex machine such as a vehicle) captured through the use of a camera, microphone, or other sensors (e.g., LIDAR, infrared, ultrasonic, doppler radar) in or connected to the user device. GUI application 117 may provide a selectable option 304 to record the captured views for later review. The term “view” refers to sensor data indicating physical attributes of an item that may be captured from a specific position relative to the item or a portion of the item (e.g., from a specific angle or distance) and/or with the item under specific environmental and/or atmospheric conditions (e.g., specific lighting, temperature, and/or weather conditions), and/or with the item in a specific state (e.g., operating, moving, in a specific configurable position or arrangement).

In step 410, the captured sensor data may be provided as an initial view (e.g., a side view of a truck in view 301) of an item may be provided to the ML model(s) 107. The models may reside in the memory of user device 111 and be executed locally by user device 111 or in a remote computing device (e.g., server) that is communicatively coupled with user device 111 via a network.

In step 415, a computing device (e.g., user device 111 or a server) may process the initial view(s) using the ML model(s) to generate descriptive information (e.g., classifications) associated with the item depicted in the initial view. This descriptive information and other feedback generated from the processing may be provided from the ML model(s) 107 back to the GUI application 117 for saving in memory or displaying to the user.

In step 420, as the descriptive information and feedback are provided to GUI application 117, the application may actively list 303 the descriptive information, such as identified features of the item, which may be scrolled and/or reviewed by the user. Additionally, based on the feedback, the user device may optionally display ancillary information about the descriptive information or about the view. For example, an indication 306, such as a highlight, circle, and/or box, indicates elements of the live or captured image indicative of or associated with particular descriptive information generated by the ML model. For example, in FIG. 3, indication 306 is illustrated as an oval, highlighting aspects of the image in view 301 related to the classification of the vehicle as a “Regular Cab” configuration.

In step 425, user device 111 (via GUI application 117) may provide the option for the user to provide additional input, for example, based on evaluating the descriptive and ancillary information. For example, based on the feedback, the GUI application 117 may further identify, for each feature listed, an option for the user to confirm the accuracy or correctness of the feature, for example, with an asterisk. Displaying this option may be based on the feature having a low confidence level (e.g., below a threshold value) of accuracy (e.g., as indicated in the feedback information). For example, GUI application 117 may provide a pop-up 305 to confirm a particular feature in the descriptive information. The option may alternatively or additionally include suggested alternative configurations or information that the user may accept or reject as being accurate. If the user provides input, that input may be provided to the ML model(s), which may re-process in step 415 the initial view (or later views) based on the user input to refine or generate new descriptive information and feedback. The process may continue to step 430 if no user input is received. Additionally, the user input, view, and descriptive information may be saved as additional training data for further training the model(s) (e.g., step 215 in FIG. 2).

In step 430, the user device 111 may determine if there are additional views of the item (e.g., complex machine) to process with the ML model(s) 107. For example, an additional view may have been previously captured and stored in user device 111 in step 405. If a video was captured and recorded, additional views may be taken from the video's frames. Alternatively, or additionally, in step 430, user device 111 may identify or suggest one or more additional views to the user via the GUI application 117 to ensure that the required image data is collected to determine all of the configuration data and to assess the condition of both the equipment and its accessories (e.g., tread depth on agricultural tires).

For example, GUI application 117 may display a suggestion window 302 depicting the next view of the item for the user to capture. Window 302 may pictorially illustrate the suggested view, may describe the view with text or audio output, or both. Suggested views of the item identified to the user may be predetermined and stored in the memory of user device 111 or another computing device. Alternatively, or additionally, suggested views may be determined by the AI/ML model and provided to user device 111 for display based on already captured and processed views (images, video, and/or audio) in step 415 and/or based on the user confirming the correctness of information generated by the model (in step 425). For example, from an initial view, the model may determine that the item is a John Deere 8R 410 MFWD Tractor with three different transmission options. Based on this determination, the model may determine that a view of the gear shift within the tractor cabin may provide sufficient data to determine which transmission is included. It may also suggest this view to the user via suggestion window 302. If an additional view is captured, the process may return to step 410, and if an additional view is suggested, the process may return to step 405 to capture those views. Multiple views (e.g., from inside and outside the tractor cabin) may be processed by the model to identify a single feature, such as which transmission the tractor includes. All of this may be managed through a device carried by the user (e.g., listing agent) via the GUI application 117 run on user device 111.

Once all user input in step 425 and all views in step 430 have been considered and processed, the process proceeds to step 435, in which the descriptive information (e.g., classifications, subclassifications, and other descriptions) is finalized. A checklist may be provided to ensure all known configuration options have been determined, and the resulting configuration data can be used to generate a consistent and accurate record (e.g., an auction or sale description using generally accepted abbreviations and nomenclature for clarity and accuracy).

Similar concepts may be applied to a more general-purpose consumer application, where purchasers in secondhand markets, like garage sales and antique stores, can photograph a product and quickly get information about its configuration and/or be prompted for additional photos to take to provide a more detailed assessment.

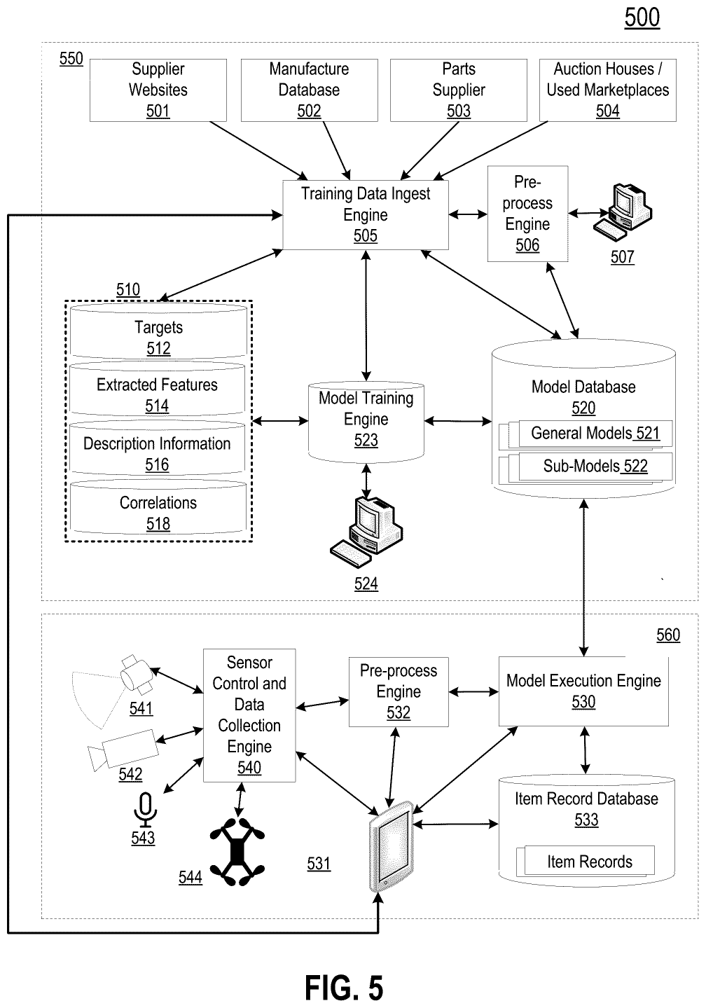

FIG. 5 illustrates a more detailed view of a system 500, which may be implemented with one or more computers that host, train, and run the ML model(s) to identify and describe items (such as complex machines) according to a plurality of classifications. System 500 comprises a plurality of computing engines (e.g., computer processes), data storage devices, and data interfaces (e.g., network connections, and sensor interfaces). While these elements are illustrated as distinct devices, they can be implemented together with a single or multiple computing devices (e.g., servers) and/or a single or multiple storage devices and/or a single or multiple data interfaces.

System 500 may include two subsystems, 550 and 560. Subsystem 550 includes several components of system 500 for training models (e.g., AI/ML models 107), which are stored in a model database 520. Subsystem 560 includes several components that use the models stored in model database 520 to identify and describe a candidate item (e.g., tractor) based on sensor data (e.g., images of the candidate item). System 500 may include some functions and features as previously described with respect to FIGS. 1-4.

Referring to the bottom of FIG. 5, subsystem 560 may include a computing device 531 (e.g., user device 111) that may coordinate, execute, and/or provide a user interface for the processes for capturing and characterizing an item of interest. While computing device 531 may include a user interface (e.g., as shown in FIG. 2), the computing device may run autonomously. Computing device 531 may communicate control commands to and receive data from a sensor control and data collection engine 540 (also referred to as sensor interface 540), which provides an interface to sensors 541 (e.g., LIDAR sensor), 542 (e.g., a camera), 543 (e.g., a microphone), and any number of additional sensors capable of capturing data indicating physical attributes of an item (e.g., a tractor). As previously described with respect to step 410, sensors may include any combination of cameras, microphones, LIDARs, proximity sensors, infrared sensors, ultrasonic sensors, doppler radar, and other sensors that, individually or in combination, capture the physical attributes of an item. For example, a facility might have multiple cameras to capture different views of wheeled vehicles rolled into an inspection area. Sensor interface 540 may control the sensors in a coordinated manner (e.g., to capture data simultaneously or sequentially) and may control equipment 544 (e.g., a quadcopter) upon which the sensors are mounted or which control other aspects of a view (e.g., lighting). For example, sensor interface 540 may position and reposition the sensors to capture different views (e.g., different angles, lighting conditions, etc.) of the item by controlling an articulating robotic arm, wheeled or tracked base, and/or uncrewed aerial vehicle (UAV) (e.g., a quadcopter) upon which the sensor is mounted.

Data captured from sensors by the sensor interface 540 may be received by pre-process engine 532 to correct errors, format, crop, trim, cleanse, or otherwise process the input to model execution engine 530. Pre-processing by engine 532 may be performed, for example, as part of previously described step 220 of FIG. 2 and/or step 405 of FIG. 4. The pre-processing may be controlled at the direction of computing device 531 and may be user-controlled (e.g., via a GUI interface to crop, highlight or otherwise manipulate the sensor data), or may be automated, e.g., by a set of rules or decision tree or AI model that selects certain parts of the data to input to the models. After pre-processing by pre-process engine 532, the data is received and processed by model execution engine 530.

Model execution engine 530 selects, retrieves, and executes one or more AI/ML models for which to process the sensor data to generate a record for the item as previously described with respect to steps 225-235 of FIG. 2 and/or steps 415-435 of FIG. 4. The models may include general models 521, for example, image recognition models or embedding models with which all of the sensor data may be processed to generate the record. The models may alternatively or additionally include sub-models(s) 522, each performing one or more tasks that create a record together. For example, one sub-model 522, when executed, may perform image recognition to identify specific views and/or features of the item. For example, an image recognition sub-model may process an initial image to determine a class of items (e.g., truck, tractor, scooter, airplane, boat, exercise equipment, other complex machine, antique, coin, etc.). Based on the recognition of the class, model execution engine 530 may retrieve a second sub-model trained and/or tailored for characterization of the recognized class of items and/or may retrieve a certain set of subclassifications to determine and populate in the record for the item. Other sub-models may be tailored for different aspects of the process, such as performing optical character recognition (OCR) of text in images (e.g., on the sidewall of the tire or on an identification plate), suggesting additional views for sensor capture, querying a user via computing device 531 to provide or confirm information, etc. One or more of the tasks performed by the sub-models may alternatively be performed by a single general model 521.

The model(s) continue to process the data to generate descriptive information to be stored in a record for the item and ancillary information that may be used by sensor interface 540, pre-process engine 532, and computing device 531 for further collection and processing of sensor data as previously described with respect to FIGS. 2 and 4. The descriptive information may be organized by model execution engine 530 and/or computing device 531 into classifications and subclassifications in an item record, which may be stored in and retrieved from item record database 533. The item records may be further organized into one or more collections, such as in an inventory management system, an auction listing, etc. The sensor data (e.g., either the raw data or pre-processed data), the item records, and the ancillary data may further be provided (e.g., from computing device 531 or model execution engine 530) to a training data ingest engine 505 and/or model training engine 523 in subsystem 550 for further training and refining of the models stored in model database 520 as further described below.

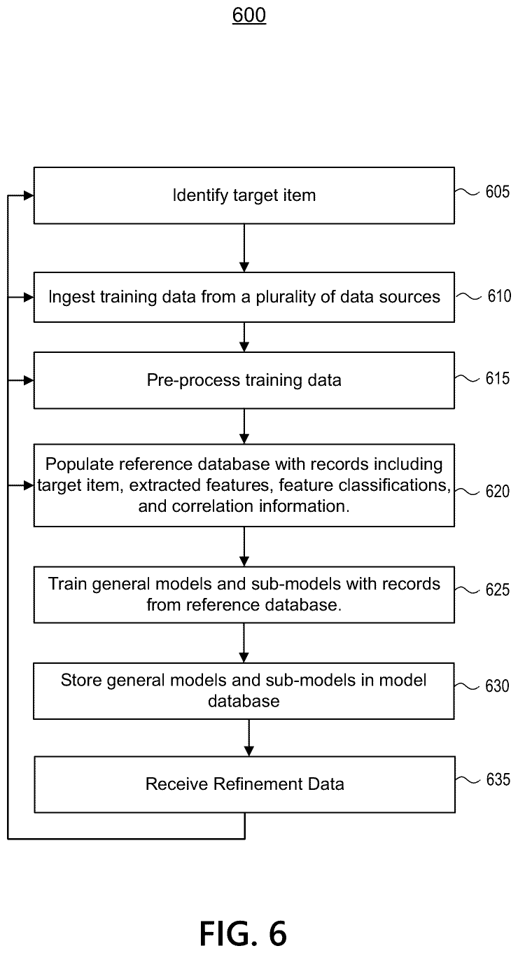

FIG. 6 illustrates a method 600 performed, for example, by subsystem 550, for training the ML models. Method 600 may, for example, be used to implement steps 205-215 of method 200 illustrated in FIG. 2. To start, in step 605, a target item is identified for which a reference record will be generated and stored, for example, in a reference database 510. The reference database 510 may include at least four types of information, including target information 512, extracted features 514, description information 516, and correlation data 518. Target information 512 identifies specific target items to be recognized by one or more models based on sensor data. An example of a target item may be a specific type of complex machine, such as a specific model of a tractor, car, or other equipment.

Extracted features 514 in the reference database 510 include information about identifiable features recognizable by the models in the sensor data. For example, if the sensor data includes an image, recognizable features in the image may include a tire, a side door, a shovel, a gearbox, a steering wheel, or other identifiable components of the target item (e.g., a tractor) in the image.

Description information 516 in the reference database 510 may include classifications and subclassifications, which include specific descriptive information about a target item, which may be organized and standardized across similar types of items. For example, a classification might be “farm equipment,” “sports cars,” “power tools,” etc. Sub-classifications include specific descriptive information that may be commonly found for a particular class of items but may vary from item to item within the class. Example subclassifications for a pickup truck are illustrated in list 303 of FIG. 3, which may include an item's manufacturer, model, tire, and wheel features, and optional equipment such as whether the truck has a regular or extended cabin, whether the power train includes 4-wheel drive (4×4), or whether the windows are tinted. Other examples of subclassifications include the standard and optional equipment listed in new car window stickers. Subclassifications may also be referred to generally as classifications.

Correlation information in reference database 510 includes information that associates together one or more of the following: a target item identified in the target information 512, specific features in extracted features 514, and specific classification(s) and/or sub-classification(s) in description information 516. This associated information may together form a reference record in reference database 510.

In step 610, training data is received by training data ingest engine 505 from a plurality of data sources to populate a training database 510. The plurality of data sources may include, for example, websites 501 through which goods are sold, advertised, or described (e.g., a car or tractor's manufacture webpage), a manufacturer's database of parts (e.g., which may include assembly or exploded views of complex machines with associated part information), part suppliers 503 (e.g., third-party and aftermarket part manufactures), and marketplace listings 504 (e.g., auction house listings of goods). Training data may further be supplied from the processes (e.g., FIGS. 2 and 4) and systems (e.g., computing device 531 and model execution engine 530) as previously described that run the models to recognize items and (optionally) confirm the recognition of the items through user verification.

The ingested training data may be pre-processed using pre-process engine 506, which may perform similar functions to previously described pre-process engine 532, for example, to correct errors, format data, crop images, trim, cleanse, or otherwise process the data for input to model training engine 523. Pre-process engine 506 may also include identifying specific extracted features (e.g., by annotating an image of the feature on the item) and generating correlation information 518 that associates the extracted feature with the target item and specific classifications and sub-classifications in description information 516. The correlation information and description information may be additionally or alternatively, included in the ingested training data,

The ingested and pre-processed training data may be stored as reference records in reference database 510 in step 620. The ingesting and pre-processing of the training data and populating the reference database may be performed through user-directed or autonomous processes. For example, a user may interface with training data ingest engine 505 and pre-process engine 506 via a computing device 507 to select a target device (in step 605) and direct ingest engine 505 to scrape or download training data from a specific source, such as a supplier's website or online catalog. The user may further perform the annotation of the training data and associate the annotated data with target information, classification information, and correlation information. In some examples, the user may be the training data source, for example, by photographing a target item, providing the photographs to the ingest engine 505 (e.g., via 507), annotating the photographs, and/or associating the annotation portions of the photographs with classification and subclassification values.

The training data ingest engine 505 may generate questions and possible responses about the target to guide the user in selecting training data (e.g., images) and associating the pictures or features in the image with classifications and subclassifications. For example, if the target item was identified as a John Deere 8R 410 MFWD Tractor, one question could be: “What transmissions are available on a John Deere 8R 410 MFWD Tractor?” A response to this question (e.g., from a user via computing device 507) may be IVT or e23, which are optional transmissions identified in the data source (e.g., a tractor supplier's online catalog. In this example, “transmission” is a subclassification category, and each optional transmission is a subclassification value for that category. Alternatively, or additionally, a user may manually input the identity of the target item and associate specific features of the item with classification and subclassification values.

The ingest engine may assign one or more images or other identifying data to each subclassification value, with optional annotations or other correlation information 518 generated by pre-process engine 506 to associate the subclassification value to an extractable/identifiable feature in the image(s) or other data. For example, if there are ten questions for a model/series target item and each question has three possible responses, then that is potentially 30 photos to be sourced. If one photo can confirm multiple responses, there may be less than one photo per subclassification value. A list of photos or other feature data for the target item in the reference database may be identified by engines 505 or 506 for verification by a system user (e.g., via 507). In response to the verification, data records may be populated in the reference database in step 620.

One or more of steps 605, 610, 615, and 620 may be performed autonomously by training data ingest engine 505 and pre-process engine 506 using one or more ML classification models stored in model database 520. For example, one or more models may be trained to crawl or scan a website that includes a supplier's catalog, auction list, parts supplier, etc., to identify target items (e.g., car models), download images, video or other feature information (e.g., sensor data) which are identified by the source as being of the target item. The one or more models may then identify subclassification information from the source which is associated with certain features of the target item, and determine correlations between the subclassification information and the feature information, for example, based on the source providing a correlation (e.g., by labeling an image of an SUV cabin space as including an optional third-row seat), or based on the model having been trained to autonomously recognize the feature (e.g., by being trained with other pictures of third-row seats). The autonomously recognized targets, features, subclassifications, and correlations may be saved into the reference database 510.

After the population of the reference database 510 with one or more records, model training engine 523 may then, in step 625, use that data (e.g., 510, 514, 516, and 518) to train one or models used by subsystem 560 to recognize items depicted in sensor data, identify features of the items in the sensor data and identify subclassification categories and values associated with those features, and to create a item record database as previously described with respect to subsystem 560. Trained models may then be stored in model database 520 as general models 521 and sub-models 522 as previously described. As also previously described, subsystem 550 may receive (from subsystem 560) sensor data, item records, and/or the ancillary data, and using this data, process 600 may return to any of steps 605-620 to further train and refine the models stored in model database 520.

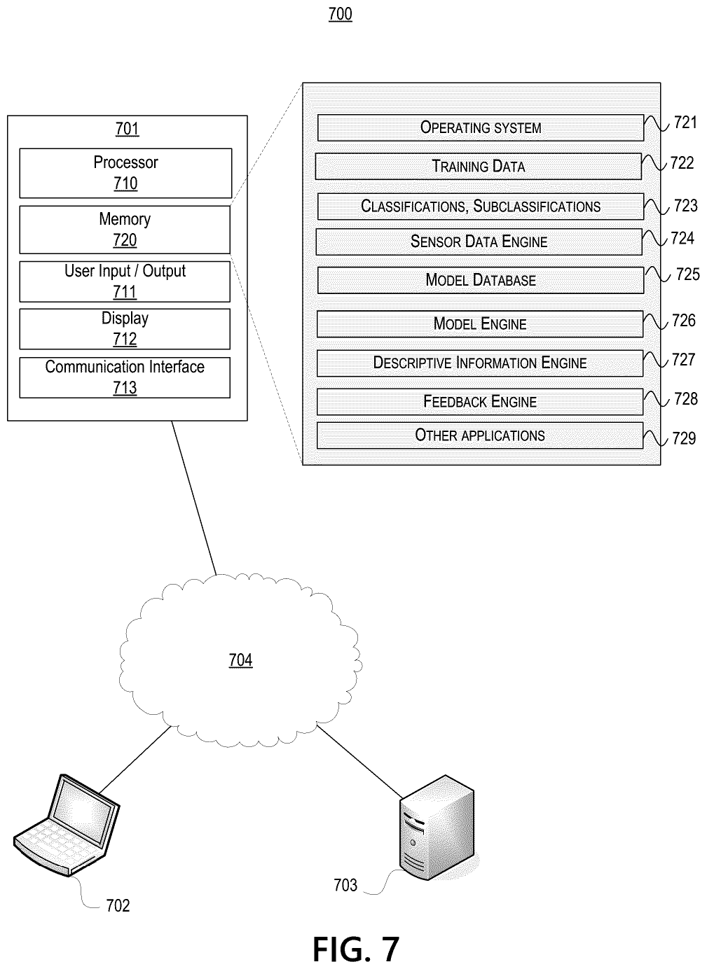

FIG. 7 illustrates an example computing device that may be used to implement user device 111 or any other computing device or server illustrated in FIGS. 1, 3, and 5 for performing the functions and methods described herein, including the methods illustrated in FIGS. 2, 4, and 6. For example, the computing device 701 may implement one or more aspects of the disclosure by retrieving from memory and/or executing instructions to perform one or more actions. The computing device 701 may represent, be incorporated in, and/or include various devices such as a desktop computer, a server, a laptop or tablet computer, a smartphone, or any other mobile computing device.

The computing device 701 may operate in a standalone environment or a networked environment with other network nodes (e.g., 702 and 703), which may be interconnected via a network 703 (e.g., implementing 114). Network 703 may include the use of the Internet, private intranets, corporate networks, local area network LANs, wireless networks, personal networks (PAN), or a combination of these. The network may use one or more protocols, such as Ethernet. Networked devices (e.g., 701, 702, and 703) and other devices (not shown) may be connected to the network with wires and cables (e.g., twisted pair wires, coaxial cable, fiber optics) or wirelessly (e.g., radio waves or other communication media).

Computing device 701 may include a processor 710, memory 720, a communication interface 713, and input/output interfaces 710 (e.g., keyboard, mouse, display, printer, etc.). Processor 710 may include one or more computer processing units (CPUs), graphical processing units (GPUs), and/or other circuitry that performs processing and/or machine learning. I/O 710 may include a variety of interface units and drives for reading, writing, displaying, and/or printing data or files, including a display. Memory 720 may include read-only memory, random-access memory, and other types described below as computer-readable medium. Memory 720 may store software for configuring computing device 701 into special-purpose computing that performs the functions of user device 111 and other computing devices described herein. Memory 720 may store operating system software 721 that controls the overall operation of the computing device 701, training data 722, and other applications 729. The computing device 701 may include two or more of any and/or all of these components (e.g., two or more processors, two or more memories, etc.) and/or other components and/or subsystems not illustrated here, connected directly (e.g., via a backplane) or networked together (e.g., cloud computing).

Memory 720 may include a database or repository of known classifications and/or subclassifications 723 from which the models select to generate descriptive data. Additionally, different models (e.g., machine learning models 107) may be stored in a model database 725, where processor 710 may initially select a specific model based on one or more views provided to processor 710. A model engine 726 may be included, comprising software for processing the sensor or training data, with a model selected from model database 725. The model engine 726 may include multiple engines, for example, one engine for each model, respectively, a specific engine for training a model, and a separate engine for processing data using the model. Memory 720 may further include pre and post-processing engines. For example, sensor data engine 724 may receive, format, and cleanse sensor data from different views (e.g., as in step 210), descriptive information engine 727 may format and filter descriptive information generated by a model, and feedback engine 728 may generate and format ancillary data (e.g., such as confidence measures) that are produced by the model.

Devices 702 and 703, as well as other devices (not illustrated), may have similar or different structures as described with respect to 701. The functionality of computing device 701 (or device 705, 707, 709), as described herein, may be spread across multiple data processing devices that distribute the processing across two or more computers. Multiple devices 701, 703, and 703 and other devices may operate in parallel.

Throughout this disclosure, “computer” may refer to computing device 710, which generally implements functionality provided by digital computing technology and/or quantum computing technology. The term “computer” is not intended to be limited to any specific type of computing device. Still, it is designed to be inclusive of all computational devices including, but not limited to: processing devices, microprocessors, application-specific circuits, field programmable gate arrays, personal computers, desktop computers, laptop computers, workstations, terminals, servers, clients, portable computers, handheld computers, cell phones, mobile phones, smartphones, tablet computers, server farms, hardware appliances, minicomputers, mainframe computers, video game consoles, handheld video game products, and/or wearable computing devices including but not limited to eyewear, wristwear, pendants, fabrics, and clip-on devices.

Some aspects of the present disclosure may be embodied as a system, method, or computer program product. Accordingly, aspects of the present disclosure may take the form of an entire hardware embodiment, an entire software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer-readable media with computer-readable program code embodied thereon.

Any combination of one or more computer-readable media may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the preceding. In the context of this document, a computer-readable storage medium may be any tangible medium that can contain or store a program for use by or in connection with an instruction execution system, apparatus, or device.

Throughout this disclosure, the term “software” may refer to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Software can be wired or embedded into hardware, including without limitation onto a microchip ASIC or FPGA, and still be considered “software” within the meaning of this disclosure. Software includes, without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Program code embodied on a computer-readable medium may be transmitted using any appropriate medium, including but not limited to wireless, wireline, optical fiber cable, RF, etc., or any suitable combination of the preceding.

The term “network” may refer to a voice, data, or other telecommunications network over which computers communicate. The term “server” may refer to a computer providing a service over a network, and a “client” may refer to a computer accessing or using a service provided by a server over a network. The terms “server” and “client” may refer to hardware, software, and/or a combination of hardware and software, depending on context. The terms “server” and “client” may also refer to endpoints of a network communication or network connection, including but not limited to a network socket connection. A “server” may comprise a plurality of software and/or hardware servers delivering a service or set of services. The term “host” may, in noun form, refer to an endpoint of a network communication or network (e.g., “a remote host”), or may, in verb form, refer to a server providing a service over a network (“hosts a website”), or an access point for a service over a network.

The terms “web,” “website,” “web server,” “web client,” and “web browser” may refer to computers programmed to communicate over a network using the HyperText Transfer Protocol (“HTTP”) and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

The term “GUI” may refer to a graphical user interface for a computing device. The design, arrangement, components, and functions of a graphical user interface will necessarily vary from device to device depending on, among other things, screen resolution, processing power, operating system, device function or purpose, and evolving standards and tools for user interface design. GUIs may include a number of widgets, or graphical control elements, which are graphical components displayed or presented to the user and which are manipulatable by the user through an input device to provide user input, and which may also display or present to the user information, data, or output.

In this disclosure, a type of computer is referred to as a “mobile communication device” or simply a “mobile device.” A mobile communication device may be but is not limited to, a smartphone, tablet PC, e-reader, satellite navigation system (“SatNav”), fitness device (e.g., a Fitbit™ or Jawbone™), or any other type of mobile computer, whether of general or specific purpose functionality. A mobile communication device may be network-enabled and communicate with a server system providing services over a telecommunication or other infrastructure network. A mobile communication device may include a mobile computer, but one which may not be commonly associated with any particular location and may be carried on a user's person and in near-constant real-time communication with a network.

The terms “artificial intelligence” and “AI” refer broadly to a discipline in computer science concerning the creation of software that performs tasks based on learned processes. One implementation of AI is supervised machine learning, where a model is trained by providing large sets of pre-classified inputs, each set representing different desired outputs from the AI. For example, if the AI is meant to recognize a human face, one set of inputs contains a human face in each image, and one set does not. The “AI” is a statistical engine that uses mathematics to identify and model data patterns common to one set but not the other. This process is known as “training” the AI. Once the AI is trained, new unclassified data is provided for analysis, and the software assesses which labels it has been trained on best fits the new data. A human supervisor may provide feedback to the AI on whether it was right, which may be used to refine its models further. Each discrete task or collection of tasks an AI is trained to perform may be referred to herein as a “model.” General-purpose AIs not trained on one specific task, notably large language models, may be trained in fundamentally the same way, using enormous data sets covering a broad range of topics, and such models produce output by, essentially, generatively predicting, based on the training data, what the following word in the response should be.

While the invention has been disclosed in conjunction with a description of specific embodiments, including those currently believed to be the preferred embodiments, the detailed description is intended to be illustrative and should not be understood to limit the scope of the present disclosure. As would be understood by one of ordinary skill in the art, embodiment other than those described in detail herein are encompassed by the present invention. Modifications and variations of the described embodiments may be made without departing from the spirit and scope of the invention.

1. A method of generating a classification record for a target object, the method comprising:
capturing, using one or more sensors, an initial view of the target object;
retrieving, from a memory, a classification model;
processing, using one or more computing devices, the initial view with the classification model to recognize physical features of the target object, and based on the recognized physical features, identify a classification category of a plurality of classification categories and a next view of the target object, wherein the plurality of classification categories indicates, respectively, a plurality of component types;
capturing, using the one or more sensors and based on the processing of the initial view, the next view of the target object;
processing the next view with the classification model to identify a classification value that indicates a specific component of the target object that is of a component type indicated by the classification category; and
storing, within the memory, the classification category and classification value in the classification record for the target object.

2. The method of claim 1, wherein the target object is a complex machine configurable with two or more interchangeable components of the component type indicated by the identified classifications category.

3. The method of claim 1, wherein the classification model comprises a plurality of sub-models, each performing a distinct task in generating the classification record.

4. The method of claim 1, wherein the one or more sensors comprises a camera, and the initial view and the next view comprise sensor data from the camera.

5. The method of claim 1, wherein the identifying of the next view is based on the identifying of the classification category.

6. The method of claim 1, further comprising:
displaying, in a graphical user interface of the one or more computing devices, an image of the initial view and an image of the next view.

7. The method of claim 6, further comprising:
displaying, in the graphical user interface, a list including a plurality of classification values indicating a plurality of components that are identified by the classification model as being within the target object, and that are within the plurality of classification categories.

8. The method of claim 7, further comprising:
providing, in the graphical user interface, a user selectable option to confirm correctness of one of the plurality of classification values.

9. The method of claim 8, updating the classification model in response to the user selectable option being selected.

10. An apparatus comprising:
one or more sensors, one or more computer processors, and memory comprising computer readable instructions and a classification model, wherein based on executing the computer readable instructions, the one or more computer processors, are configured to:
capture, using the one or more sensors, an initial view of a target object;
process the initial view using the classification model to recognize physical features of the target object and to identify, based on the recognized physical features, a classification category of a plurality of classification categories and a next view of the target object, wherein the plurality of classification categories indicates a respective plurality of component types;
capture, using the one or more sensors, the next view of the target object;
process the next view with the classification model to identify a classification value that indicates a specific component of the target object that is of a component type indicated by the classification category; and
store, in a classification record within the memory, the classification category and classification value.

11. The apparatus of claim 10, wherein the target object is a complex machine configurable with two or more interchangeable components within the component type indicated by the classification category.

12. The apparatus of claim 10, wherein the classification model comprises a plurality of sub-models, each configured to perform a distinct task in generating the classification record.

13. The apparatus of claim 10, wherein the one or more sensors comprises a camera, and the initial view and the next view comprise sensor data from the camera.

14. The apparatus of claim 10, wherein based on executing the computer readable instructions and the classification model, the one or more computer processors, are configured to identify the next view based on the identifying of the classification category.

15. The apparatus of claim 10, further comprising:
a computer display, wherein, based on executing the computer readable instructions, the one or more computer processors, are configured to display, in a graphical user interface displayed by the computer display, an image of the initial view and an image of the next view.

16. The apparatus of claim 15, wherein, based on executing the computer readable instructions, the one or more computer processors are configured to display, in the graphical user interface, a list including a plurality of classification values indicating a plurality of components that are identified by the classification model as being within the target object, and that are within the plurality of classification categories.

17. The apparatus of claim 16, wherein, based on executing the computer readable instructions, the one or more computer processors are configured to provide, in the graphical user interface, a user selectable option to confirm correctness of one of the plurality of classification values.

18. The apparatus of claim 17, wherein, based on executing the computer readable instructions, the one or more computer processors are configured to update the classification model in response to the user selectable option being selected.

19. A portable computing device, comprising:
a camera;
memory comprising computer readable instructions; and
one or more computer processors that based on executing the computer readable instructions are configured to:
capture, using the camera, initial data representing an initial view of a target object;
transmit the initial data to a server;
receive, from the server in response to the initial data, an indication of a physical feature of the target object, a classification category of a plurality of classification categories, and a next view of the target object, wherein the plurality of classification categories indicates a respective plurality of component types;
capture, using the camera, next data representing the next view of the target object;
transmit the next data to the server;
receive, from the server in response to the next data, a classification value that indicates a specific component of the target object that is of a component type indicated by the classification category; and
store, in a classification record within the memory, the classification category and classification value.

20. The portable computing device of claim 19, further comprising a computer display, wherein based on executing the computer readable instructions, the one or more computer processors are configured to:
present, in a graphical user interface on the computer display, a user selectable option to confirm correctness of the classification value; and
transmit, to the server, that the user selectable option has been selected.
